(19) United States
(12) Patent Application Publication
(10) Pub. No.: US 2017/0023221 A1
(43) Pub. Date: Jan. 26, 2017

(54) AN ILLUMINATION SYSTEM

(71) Applicant: NUALIGHT LIMITED, Cork (IE)

(72) Inventors: Andreas SCHUH, Amsterdam (NL); Andrew CRONIN, Alkmaar (NL); Daniel LINEHAN, Cork (IE); Christian BLANDIN, Ballincollig, County Cork (IE)

(73) Assignee: NUALIGHT LIMITED, Cork (IE)

(21) Appl. No.: 15/113,283

(22) PCT Filed: Jan. 21, 2015
(86) PCT No.: PCT/EP2015/051103

§ 371 Date: Jul. 21, 2016

(30) Foreign Application Priority Data
Jan. 23, 2014 (EP) 14152275.5

(51) Int. Cl. F21V 23/04; F21V 15/015; F21V 31/00; F21S 9/02; F21S 4/28; F21V 3/00; F21V 15/00

(52) U.S. Cl. CPC F21V 23/0471; F21V 3/00; F21V 15/015; F21V 15/005; F21S 9/024; F21S 4/28; F21V 31/005; F21Y 2115/10

(57) ABSTRACT

A luminaire (100) has an elongate tubular shell (1) and an elongate internal chassis (2) within the shell dividing space within the shell between a first compartment for electrical components and a second compartment for optical components (7, 6). The luminaire has a sealing cap (3, 4) at each end, and at least one of which supports an auxiliary active component for an application such as emergency lighting or car parking management. The shell (1) has features 1(a) for desired optical properties. The only seals are at the ends, between the end caps and the shell, and these are via sealing rings (17).

### INTRODUCTION

Field of the Invention

The invention relates to LED luminaries and to illumination systems incorporating such luminaries.

An objective is to provide improved robustness and/or improved versatility.

### SUMMARY OF THE INVENTION

According to the invention there is provided a luminaire comprising:
an elongate tubular shell,
an elongate internal chassis within the shell dividing space within the shell between a first compartment housing electrical components and a second compartment housing optical components,
at least one LED substrate being attached to the internal chassis in the second compartment, and
an end cap at each end of the shell and being sealed to the shell at a seal extending around the circumference of the shell, the end caps being modular for application-specific use.

In one embodiment, at least one of said end caps supports an auxiliary component. In one embodiment, the auxiliary active component includes an emergency light emitter. In one embodiment, the auxiliary component includes a sensor. In one embodiment, the auxiliary component includes an indicator to indicate availability of one or more empty parking spaces associated with the luminaire. Preferably, the luminaire includes a communications interface for uploading vehicle sensor data. In one embodiment, the luminaire includes a sensor and a local circuit for activating an auxiliary component in response to a sensed condition. In one embodiment, the sensor includes a sensor for detecting a vehicle. In one embodiment, the luminaire includes a circuit for communicating with components of a parking management system. In one embodiment, the sensor includes a person sensor.

In one embodiment, the second compartment includes a diffuser extending within the shell and over the LEDs, to reduce glare provide more uniform illumination.

In one embodiment, the shell has integral optical features forming a wall of the second compartment. In one embodiment, the shell is of extruded polycarbonate material.

In one embodiment, at least one end cap comprises a bezel which is pressed by fasteners against the shell via a sealing ring, and a cap housing which is pressed by fasteners against the bezel via a sealing ring.

In one embodiment, the bezel is fastened to the chassis by fasteners including springs configured to maintain even pressure on the sealing ring and to compensate for relative thermal expansion of the tubular shell and the chassis. In one embodiment, the cap housing is clamped to the bezels via the sealing ring by rotation of cam surfaces.

In one embodiment, the end cap comprises a manually-operated handle, rotation of which causes mutual rotation with a cam surface. In one embodiment, the cap housing has a locking pin which is arranged to extend through a socket in the bezel, said pin having at least one projection arranged to slide on a cam surface of the bezel upon rotation of the pin.

In one embodiment, the handle has a cam and is pivotally mounted onto the cap housing about a transverse axis and is linked with the locking pin, rotation of the handle about said axis causing the cam to press against the cap housing to pull the cap housing against the bezel.

In one embodiment, at least one cap includes a security lock requiring a special tool to release the cap from the shell. In one embodiment, at least one end caps includes ducts for training cables.

In another aspect, the invention provides an illumination system comprising a plurality of luminaries as defined above in any embodiment, and a management system linked with said luminaries.

In one embodiment, the system includes car parking sensors and space vacancy indicators.

### DETAILED DESCRIPTION OF THE INVENTION

### Brief Description of the Drawings

The invention will be more clearly understood from the following description of some embodiments thereof, given by way of example only with reference to the accompanying drawings in which:—

FIGS. 1 and 2 are top and underneath perspective views of a luminaire of the invention;

FIG. 3 is an exploded view of the main body of the luminaire;

FIG. 4 is an exploded view of a left end cap

FIG. 5 is a view showing components within the main body and close to, or overlapping into, the left end cap;

FIG. 6 is an exploded view of a right end cap;

FIG. 7 is a view of components within the main body and close to, or overlapping into, the right end cap;

FIGS. 8(a) to (d) and 9(a) to (c) are various perspective views showing components of the right end cap in more detail;

FIG. 10 is a longitudinal sectional view along the length of the luminaire;

FIG. 11 is a cut-away perspective view through the main body of the luminaire;

FIG. 12 is a cross-sectional view through the luminaire;

FIG. 13 is a cut-away perspective view through the luminaire, showing components with in the main body in more detail;

FIGS. 14 and 15 are side and underneath views showing an end cap configured with an emergency light, and FIGS. 16 and 17 show how the emergency light can be adjusted; and

FIGS. 18 and 19 are longitudinal section views showing the end cap of FIGS. 14 to 17 in more detail.

### DESCRIPTION OF THE EMBODIMENTS

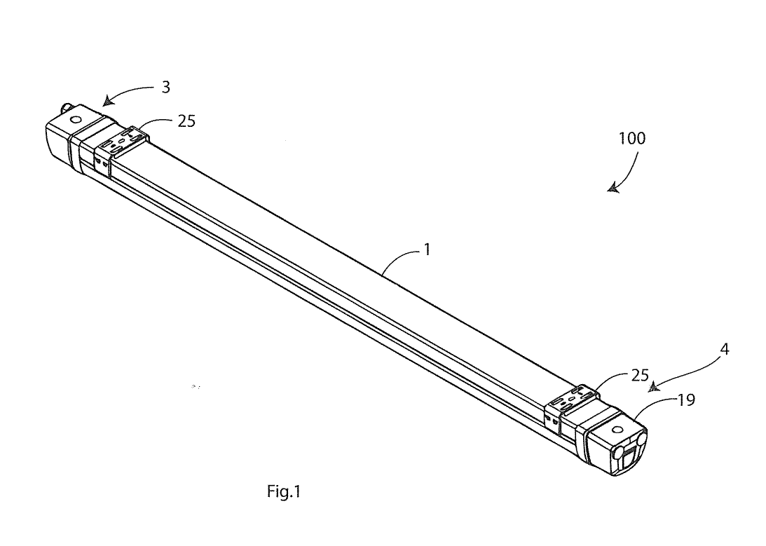

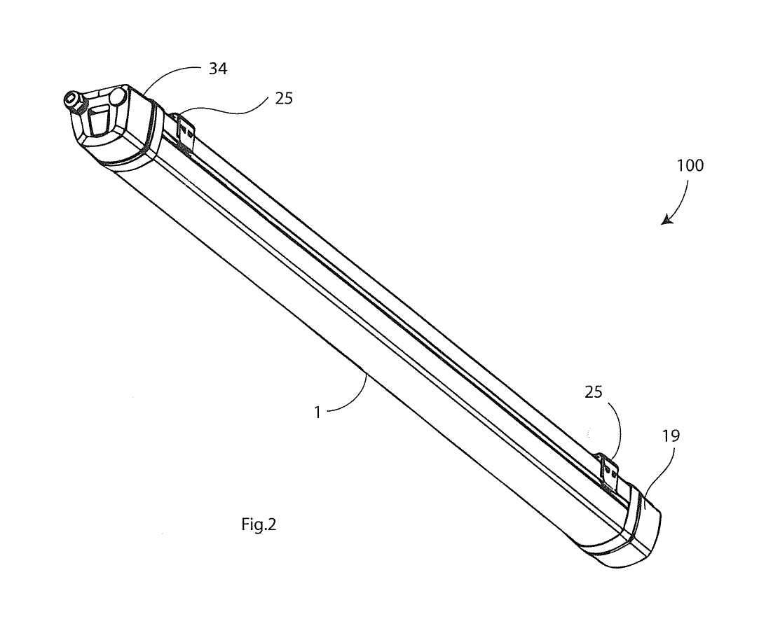

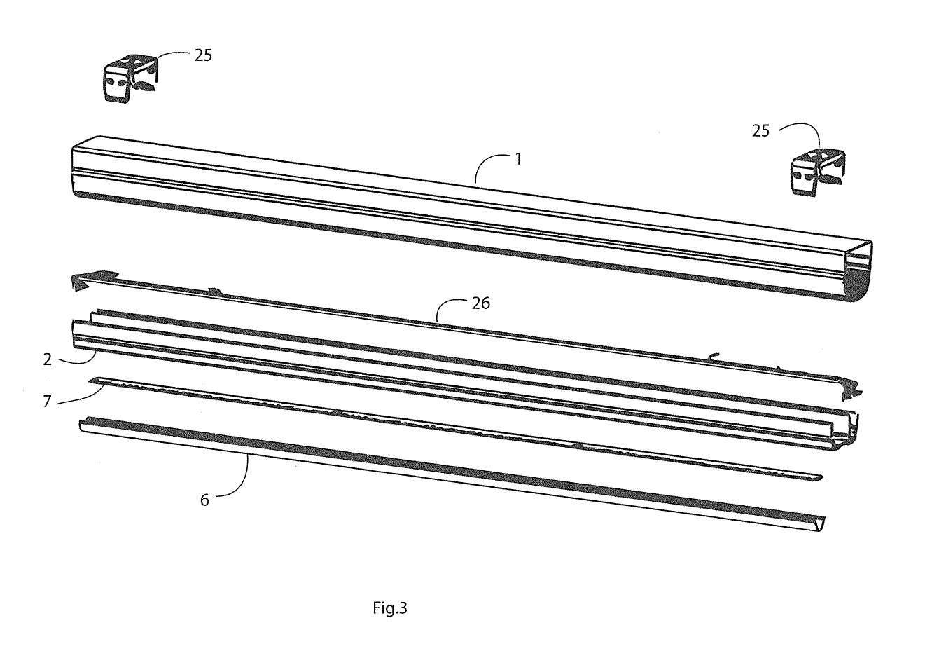

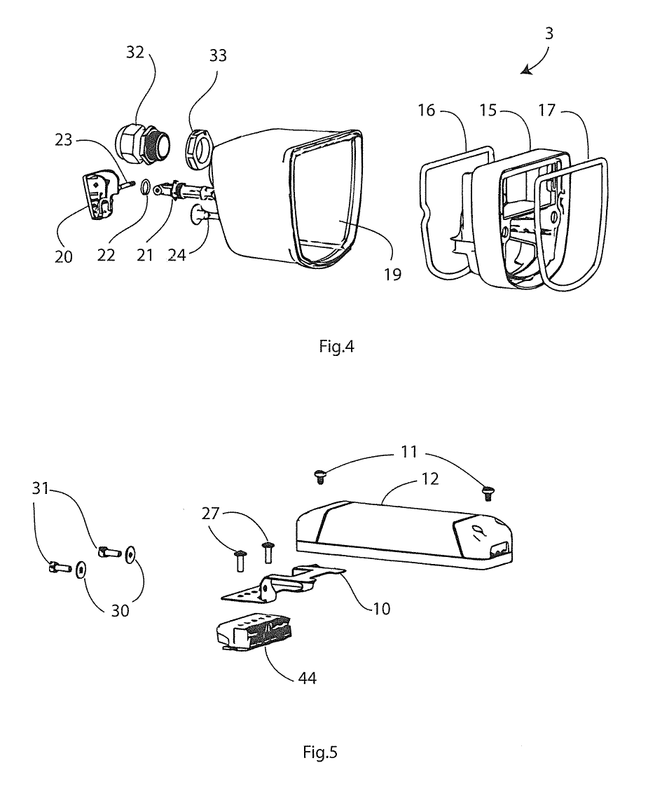

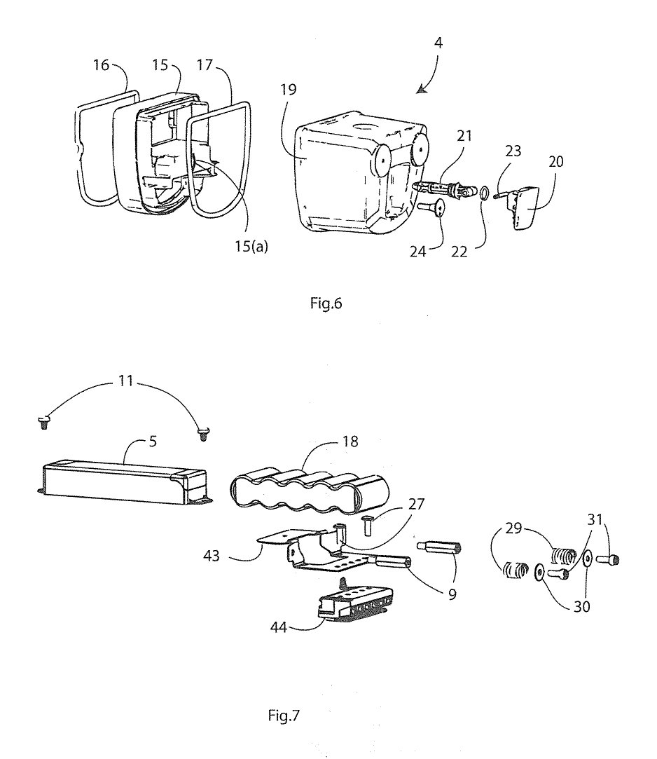

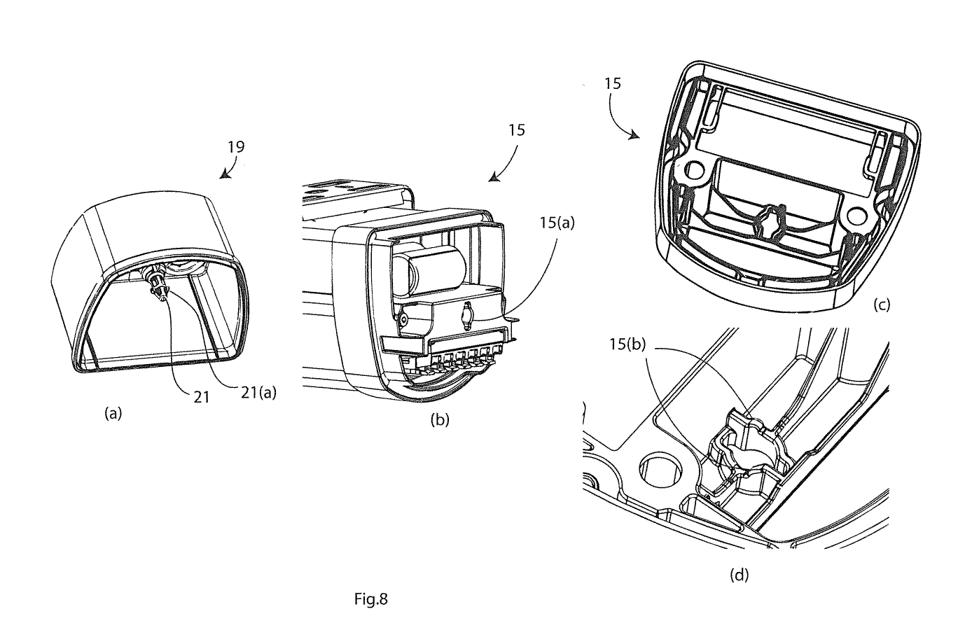

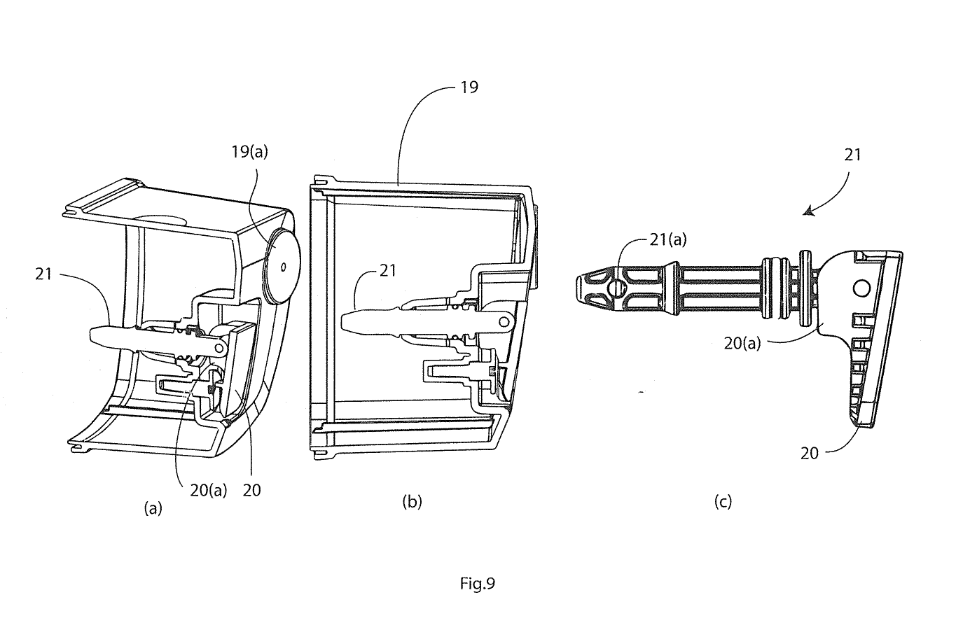

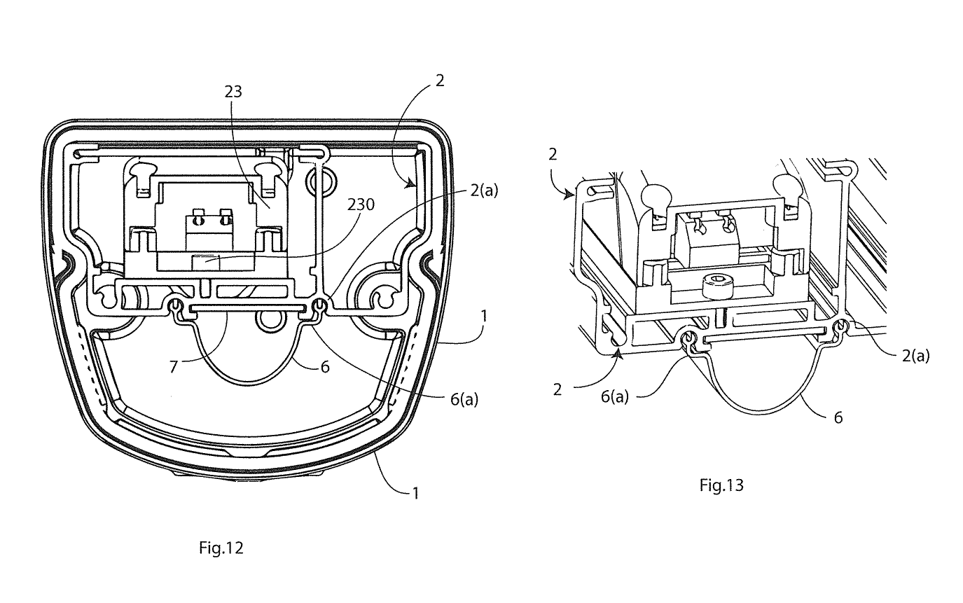

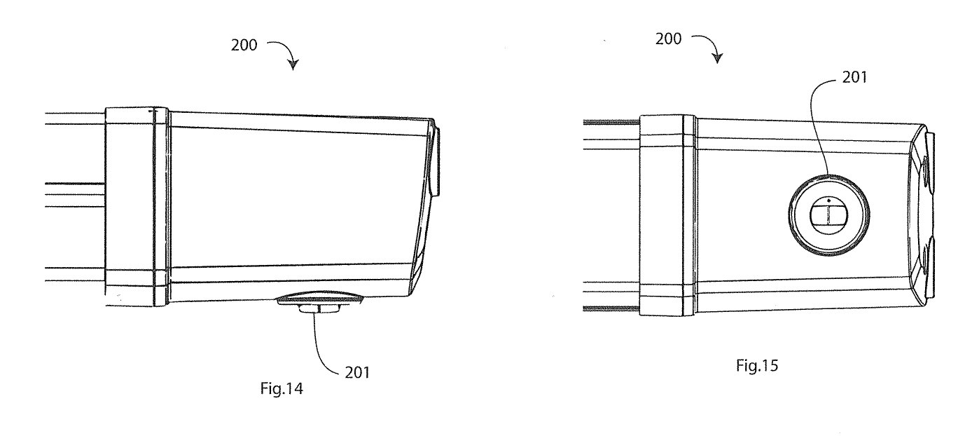

Referring to FIGS. 1 to 13 a luminaire 100 comprises an elongate transparent plastics outer shell 1, which is tubular, within which there is an internal extrusion chassis 2 of generally U-shaped configuration. The chassis 2 is an Aluminium extrusion. The internal chassis 2 forms a first (upper) compartment for power components and a second (lower) compartment for optical components including an LED board 7 and a diffuser 6. As shown in FIG. 3 the power components include a wiring harness 26 extending along the length of the luminaire within the shell 1.

The luminaire may be mounted using brackets 25 which are C-shaped, with downwardly-depending flanges to engage sides of the shell 1. Accordingly, they can be moved to any desired location along the length of the luminaire 100.

FIGS. 1 and 2 show the overall arrangement. The luminaire comprises an elongate main body comprising the shell 1 and what it encloses. At each end there are left and right end caps 3 and 4 respectively, which are mirror images of each other. The end caps 3 and 4 have main housings 19.

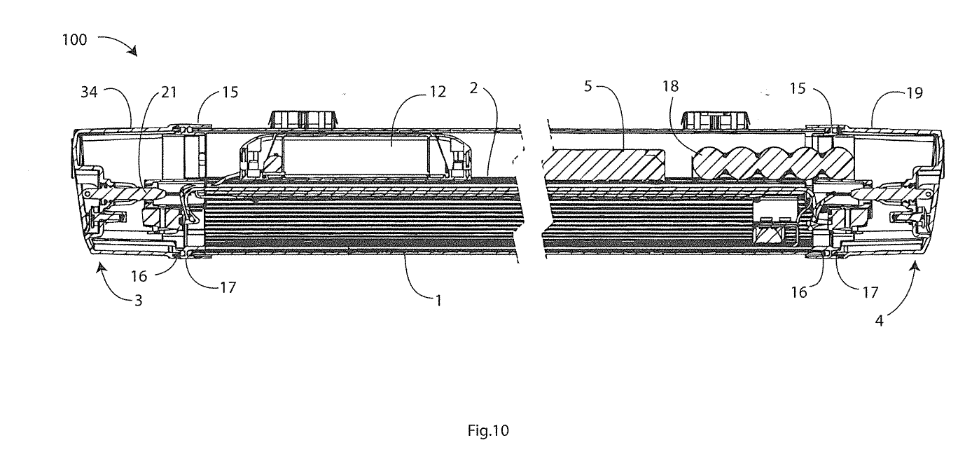

The overall composition of the luminaire 100 is best viewed in FIG. 10.

The power components are mounted on the chassis 2 and some of them overlap into the end caps 3 and 4. They include a bracket 43, a 6-pole cage clamp connector 44, an emergency driver 5, tapped spacers 9 (M4×25) for the bracket 43, and a bracket 10. Also, there is an emergency battery 18 which overlaps into the end cap 4. There are also Wago™ screws (4×12 mm) 27 for the bracket 43. The driver is bolted onto the chassis 2. The bracket 43 and any other component may be supported by any suitable arrangement of fasteners onto the chassis. The arrangement of the end caps allows space for any component to extend beyond the length of the shell 1 and into the space formed by the bezel 15 and the cap housing 19. This is particularly advantageous because such power and drive components may connect to auxiliary components in the end caps instead of or in addition to the LED drive circuit 7.

Each end cap 3 and 4 comprises, from the inner end out, a seal 16, a bezel 15, a seal 17, and a cover 19. There is also a locking clip 20 with a cam 20(a), which controls a locking pin 21 via a sealing ring 22 and an axle 23. There is also a locking clip security screw 24.

Springs 29, washers 30 (SS M4 large 12 mm), and a screw 31 (M4×12) are provided for securing the bezel 15 to the main body, at the chassis 2. The springs 29 are configured to maintain even pressure on the sealing ring and to compensate for relative thermal expansion of the tubular shell and the chassis 2.

The luminaire 100 is a sealed linear luminaire with multiple optical configurations. It is suitable for general lighting applications, including sites where it needs to be waterproof, to a standard such as IP 67. The ends may have any desired configuration such as housing auxiliary LEDS for applications such as emergency signaling, or for indicating things such as availability of an associated parking space in a car park.

One or both end cap may have an auxiliary component such as an indicator to indicate availability of one or more empty parking spaces associated with the luminaire, and/or a communications interface for uploading vehicle sensor data, and/or a sensor and a local circuit for activating an auxiliary component in response to a sensed condition, and/or a sensor for detecting a vehicle, and/or a circuit for communicating with components of a parking management system.

The LED boards 7 are attached to the internal metal chassis 2. They are covered with the diffuser 6, which reduces glare and makes the lighting uniform.

The assembled chassis 2 is contained in the extruded plastic polycarbonate tube 1, with engraved features 1(a) that act to deliberately focus the light in specific desirable directions.

The brackets 25 can be slid to any desired location along the length of the tubular shell 1. The end caps 3 and 4 are modular and can each include auxiliary circuits and/or output devices such as light emitters or sound emitters. The only seals required are the very short peripheral seals 17 around each end of the tube 1. This provides very little opportunity for moisture ingress, as compared to the conventional approach of a cover being bolted over a base with a seal extruding along the length of the luminaire.

Each bezel 15 and inner sealing ring 16 is screwed to the inner chassis 2 using the screws and springs 29 and 31 to maintain even pressure on the bezel seals 16 under all design conditions.

This attachment compensates for thermal expansion variation between the plastics outer shell 1 and the internal A1 chassis 2.

The end cap cover 19 is pressed against the bezel 15 via the gasket seal 17 by the locking pin 21 in a twisting action of the locking pin 21. The latter extends through a bayonet socket 15(a) in the bezel 15 and upon rotation of the locking clip 20 and the pin 21 radial projections 21(a) slide on internal tapered surfaces 15(b) of the bezel 15 to cause pressure to be applied against the seal 17. The pin 21 can only be inserted through the bayonet socket 15(a) when the clip 20 is pulled out and is rotated to be vertical. That way, the projections 21(a) fit through the socket 15(a). The action of pressing the housing 19 against the bezel 15 is in two parts:
(a) A first part in which the clip 20 is rotated form the outer vertical position to the outer horizontal position, causing the projections 21(a) to slide on the cam or tapered internal surfaces 15(b) of the bezel socket 15(a).
(b) A second part in which the clip 20 is rotated about the axle 23 so that its cam surface 20(a) presses against the external surface of the housing 19 o pull the housing 19 more tightly against the bezel 15.

Hence, rotation of the clip 20 about the axle 23 from the outer position to the inner position completes the action of mutual pressing of the bezel 15 against the cap housing 19. This ensures positive and even pressure, yielding repeatable and reliable sealing even if the unit is opened multiple times.

To prevent casual interference with the connections an additional screw with security head (24) is provided that when fitted interferes with the rotation of the bayonet assembly 20/21 so that the cover cannot be removed without removal of the security screw.

All covers can be removed and replaced and electrical connections made without the use of screwdrivers or fasteners, speeding the installation. Connections are secure through the use of sprung contact electrical wire connector—as distinct from a screwed terminal.

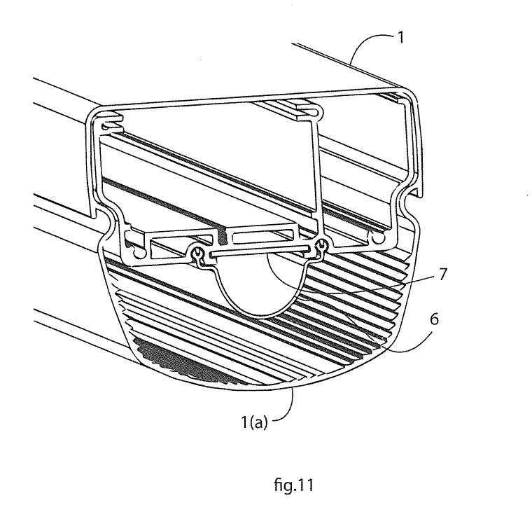

The illumination pattern is modular because a desired inner diffuser 6 and/or shell with different internal features 1(a) can be provided. This can be in the factory or on-site. This is shown in FIGS. 11 to 13. As shown most clearly in these drawings, the diffuser 6 has a pair of lateral flanges 6(a) which engage in longitudinal grooves 2(a) of the chassis 2. This allows the diffuser to be easily slid into place, whether in the factory or later for re-configuration of the luminaire on site.

The installer can fit cables through openings 19(a) of the covers 19 and into the tube 1 through an auxiliary channel in the rear of the aluminium chassis 2.

The end caps 3 and 4 provide the ability to configure the luminaire with any desired configuration of auxiliary functionality. This arises because the caps 23 and 4 can house external components such as light sources or sound emitters, and because they are directly linked to the power components above the chassis 2 within the tube 1.

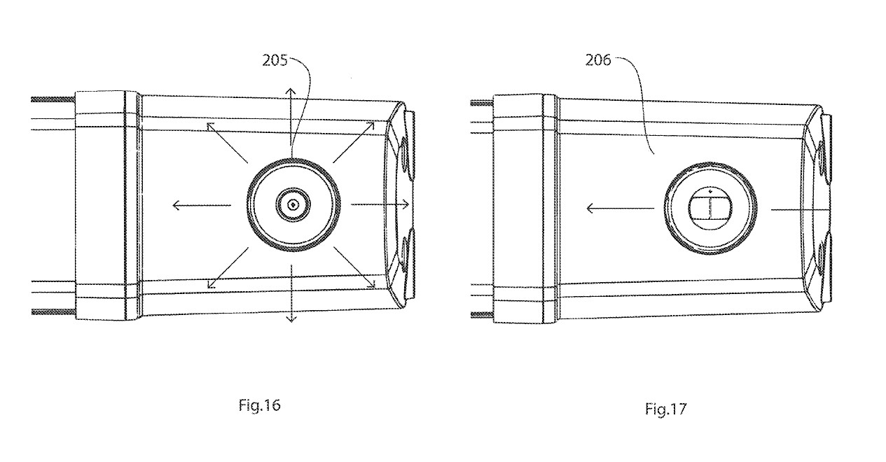

An optional feature is that integrated emergency lighting can be provided, allowing similarly fully-sealed emergency escape lighting in the event of mains power failures. FIGS. 14 to 18 show an end cap 200 with an emergency light 201. The emergency light can be fitted in a modular manner, so that it may be a light 205 with uniform illumination around 360° or a light 206 with longitudinal illumination only.

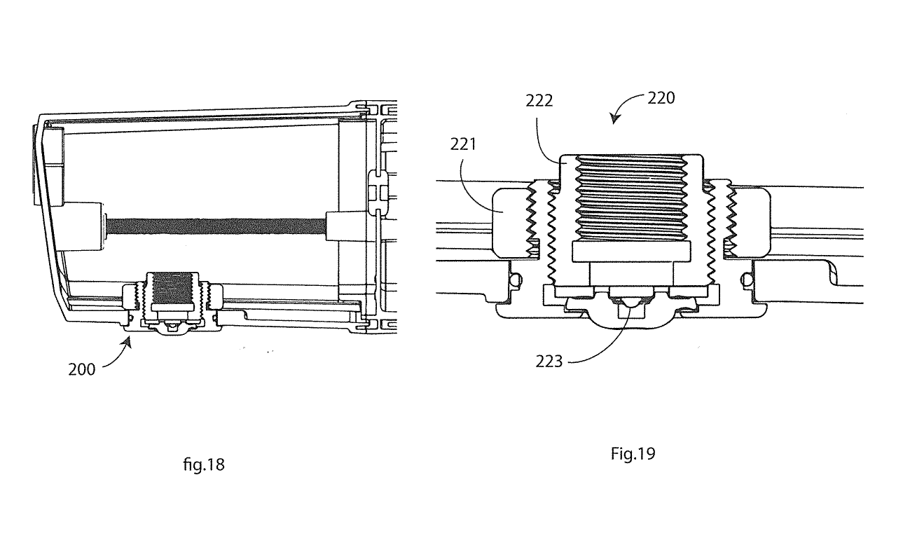

FIGS. 18 and 19 show and emergency light 220 inserted into the end cap by engagement of a threaded spindle 222 into a socket 220. Hence insertion of the emergency light involves only removing the nut 221, and removing then the full EM module. Electrical connectivity is provided via a harness linking the EM module to the emergency power supply.

In various embodiments the luminaire has a sensor such as a vehicle sensor and a communications interface for uploading vehicle sensor data. The communications may be wired or wireless.

An optional PR can be integrated into a version of one cover of the luminaire. This allows the user to set a lower level of operating power (light level) until the passive infrared detector detects someone's presence. The light then operates at full power for a period that is set by means of a potentiometer on the luminaire or by some other means of remote control e.g. a hand-held infrared controller or a wired or wireless control system to which an array of luminaries are connected. It may also be allowed to set the high and low operating light levels.

An array of luminaries may be controlled in such a way as to behave as group where triggering any one sensor may lead to the automatic triggering of others. The resultant system may operate so that all networked luminaries may increase their brightness as a response, or only those closest to the triggered device.

The invention is not limited to the embodiments described but may be varied in construction and detail.

1-23. (canceled)

24. A luminaire comprising:
an elongate tubular shell,
an elongate internal chassis within the shell dividing space within the shell between a first compartment housing electrical components and a second compartment housing optical components,
at least one LED substrate being attached to the internal chassis in the second compartment, and
an end cap at each end of the shell and being sealed to the shell at a seal extending around the circumference of the shell, the end caps being modular for application-specific use.

25. The luminaire as claimed in claim 24, wherein at least one of said end caps supports an auxiliary component.

26. The luminaire as claimed in claim 24, wherein at least one of said end caps supports an auxiliary component; and wherein the auxiliary component includes an emergency light emitter.

27. The luminaire as claimed in claim 24, wherein at least one of said end caps supports an auxiliary component; and wherein the auxiliary component includes a sensor.

28. The luminaire as claimed in claim 24, wherein at least one of said end caps supports an auxiliary component; and wherein the auxiliary component includes an indicator to indicate availability of one or more empty parking spaces associated with the luminaire.

29. The luminaire as claimed in claim 24, wherein at least one of said end caps supports an auxiliary component; and wherein the auxiliary component includes a sensor; and wherein the luminaire includes a communications interface for uploading vehicle sensor data.

30. The luminaire as claimed in claim 24, wherein at least one of said end caps supports an auxiliary component; and wherein the auxiliary component includes a sensor; and wherein the luminaire includes a communications interface for uploading vehicle sensor data; and wherein the luminaire includes a sensor and a local circuit for activating an auxiliary component in response to a sensed condition.

31. The luminaire as claimed in claim 24, wherein at least one of said end caps supports an auxiliary component; and wherein the auxiliary component includes a sensor; and wherein the sensor includes a sensor for detecting a vehicle.

32. The luminaire as claimed in claim 24, wherein at least one of said end caps supports an auxiliary component; and wherein the auxiliary component includes a sensor; and wherein the sensor includes a sensor for detecting a vehicle; and wherein the luminaire includes a circuit for communicating with components of a parking management system.

33. The luminaire as claimed in claim 24, wherein at least one of said end caps supports an auxiliary component; and wherein the auxiliary component includes a sensor; and wherein the sensor includes a person sensor.

34. The luminaire as claimed in claim 24, wherein the second compartment includes a diffuser extending within the shell and over the LEDs, to reduce glare provide more uniform illumination.

35. The luminaire as claimed in claim 24, wherein the shell has integral optical features forming a wall of the second compartment.

36. The luminaire as claimed in claim 24, wherein the shell has integral optical features forming a wall of the second compartment; and wherein the shell is of extruded polycarbonate material.

37. The luminaire as claimed in claim 24, wherein at least one end cap comprises a bezel which is pressed by fasteners against the shell via a sealing ring, and a cap housing which is pressed by fasteners against the bezel via a sealing ring.

38. The luminaire as claimed in claim 24, wherein at least one end cap comprises a bezel which is pressed by fasteners against the shell via a sealing ring, and a cap housing which is pressed by fasteners against the bezel via a sealing ring; and wherein the bezel is fastened to the chassis by fasteners including springs configured to maintain even pressure on the sealing ring and to compensate for relative thermal expansion of the tubular shell and the chassis.

39. The luminaire as claimed in either of claim 24, wherein at least one end cap comprises a bezel which is pressed by fasteners against the shell via a sealing ring, and a cap housing which is pressed by fasteners against the bezel via a sealing ring; and wherein the cap housing is clamped to the bezels via the sealing ring by rotation of cam surfaces.

40. The luminaire as claimed in claim 24, wherein at least one end cap comprises a bezel which is pressed by fasteners against the shell via a sealing ring, and a cap housing which is pressed by fasteners against the bezel via a sealing ring; and wherein the cap housing is clamped to the bezels via the sealing ring by rotation of cam surfaces; and wherein the end cap comprises a manually-operated handle, rotation of which causes mutual rotation with a cam surface.

41. The luminaire as claimed in claim 24, wherein at least one end cap comprises a bezel which is pressed by fasteners against the shell via a sealing ring, and a cap housing which is pressed by fasteners against the bezel via a sealing ring; and wherein the cap housing is clamped to the bezels via the sealing ring by rotation of cam surfaces; and wherein the end cap comprises a manually-operated handle, rotation of which causes mutual rotation with a cam surface; and wherein the cap housing has a locking pin which is arranged to extend through a socket in the bezel, said pin having at least one projection arranged to slide on a cam surface of the bezel upon rotation of the pin.

42. The luminaire as claimed in claim 24, wherein at least one end cap comprises a bezel which is pressed by fasteners against the shell via a sealing ring, and a cap housing which is pressed by fasteners against the bezel via a sealing ring; and wherein the cap housing is clamped to the bezels via the sealing ring by rotation of cam surfaces; and wherein the end cap comprises a manually-operated handle, rotation of which causes mutual rotation with a cam surface; and wherein the handle has a cam and is pivotally mounted onto the cap housing about a transverse axis and is linked with the locking pin, rotation of the handle about said axis causing the cam to press against the cap housing to pull the cap housing against the bezel.

43. The luminaire as claimed in claim 24, wherein at least one cap includes a security lock requiring a special tool to release the cap from the shell.

44. The luminaire as claimed in claim 24, wherein at least one end caps includes ducts for training cables.

45. An illumination system comprising a plurality of luminaries of claim 24, and a management system linked with said luminaries.

46. The illumination system as claimed in claim 45, wherein the system includes car parking sensors and space vacancy indicators.
